(19) United States
(12) Patent Application Publication
(10) Pub. No.: US 2008/0164625 A1
(43) Pub. Date: Jul. 10, 2008

(54) Packing elements for mass transfer applications

(75) Inventors: Hassan S. Niknafs, Stow, OH (US); Robert L. Miller, Stow, OH (US)

Correspondence Address: SAINT-GOBAIN CORPORATION, P.O. BOX 15008, ONE NEW BOND STREET, INTELLECTUAL PROPERTY DEPART., WORCESTER, MA, 01615-0008, US

(73) Assignee: Saint-Gobain Ceramics & Plastics Inc.

(21) Appl. No.: 11/651,834

(22) Filed: Jan. 10, 2007

(51) Int. Cl. B01F 3/04

(52) U.S. Cl. 261/94; 261/DIG. 72

(57) ABSTRACT

This invention provides a packing element for use in a chemical processing apparatus housing a mass transfer reaction. The packing element has lobes and channels radially disposed around a common axis and alternately spaced from one another. The lobes abut at least 60% of the circumference of the smallest circle that circumscribes the element and the channels form openings that abut no more than 40% of the circumference.

### BACKGROUND OF THE INVENTION

This invention generally relates to a packing element for use in mass transfer applications within a chemical processing apparatus. More particularly, embodiments of this invention are concerned with a plurality of packing elements that are randomly oriented in a vessel in which two fluids are made to contact each other to facilitate a desired mass transfer reaction. Mass transfer packing elements are used in chemical plants to facilitate processes such as decomposition, absorption, distillation and scrubbing of chemicals.

Examples of packing elements for use in mass transfer applications are disclosed in the following patents: U.S. Pat. No. 5,304,423; U.S. Pat. No. 5,747,143 and U.S. Pat. No. 6,007,915.

### BRIEF SUMMARY OF THE INVENTION

In particular embodiments, the present invention provides a packing element for mass transfer applications, a chemical processing apparatus and a process that use the packing elements.

In one embodiment, a packing element includes a peripheral wall defining at least three lobes and at least three channels radially disposed around a common axis and alternately spaced from one another. The lobes abut at least 60% of the circumference of the smallest circle that circumscribes the wall and the channels form openings that abut no more than 40% of the circumference.

Another embodiment relates to a chemical processing apparatus having a plurality of randomly oriented ceramic packing elements wherein the majority of elements each comprises a peripheral wall that defines at least three lobes and at least three channels that are radially disposed around a common axis and alternately spaced from one another. The lobes abut at least 60% of the circumference of the smallest circle that circumscribes the wall and the channels form openings that abut no more than 40% of the circumference.

Another embodiment relates to a mass transfer process comprising the step of simultaneously exposing at least two fluids to a plurality of randomly oriented ceramic packing elements wherein the majority of the elements each comprises a peripheral wall that defines at least three lobes and at least three channels radially disposed around a common axis and alternately spaced from one another. The lobes abut at least 60% of the circumference of the smallest circle that circumscribes the wall and the channels form openings that abut no more than 40% of the circumference.

### BRIEF DESCRIPTION OF THE DRAWINGS

FIG. 1 is a chemical processing apparatus that contains a plurality of mass transfer packing element of one embodiment according to this invention;

FIG. 2 is a first embodiment of a mass transfer packing element according to this invention; and

FIG. 3 is a second embodiment of a mass transfer packing element according to this invention.

### DETAILED DESCRIPTION OF THE INVENTION

As used herein, the phrase “chemical processing apparatus” is intended to describe equipment, such as tanks, burners, combustion chambers, piping, etc., that receives one or more raw materials and then chemically and/or physically converts it to one or more end products that are discharged from the apparatus. The conversion may involve desorption or absorption, a physical change (e.g., liquid to gas) to the raw material's state of matter and/or an increase or decrease in the temperature of the raw material. Chemical reactors are widely used in chemical manufacturing industries for a variety of purposes and are considered to be a subset of the phrase chemical processing apparatus.

The phrase “mass transfer”, when used herein, may be defined as the technology for moving one species in a mixture relative to another, and it consists basically of two types of operations: separation of components from each other or mixing them together. The mixture, which may be referred to herein as a fluid, may be a gas or a liquid. For such applications, the mixture to be treated is passed through a column containing randomly oriented packing elements which may be referred to herein as media. The packing elements are considered to be randomly oriented if they have been dumped into the reaction vessel without attempting to place or otherwise physically restrain the final orientation of the packing elements in the vessel. While some randomly oriented packing elements are designed to preferentially orient during the dumping process, thereby causing some of the elements to prefer a more horizontal or vertical orientation than would be achieved if the elements were completely randomly oriented, the elements are still considered to be randomly oriented if the individual elements are not deliberately restrained during the loading process. In contrast, monolith packing elements are carefully placed in a reaction vessel in order to align passageways in one packing element with passageways in another packing element. The labor costs and additional down time associated with loading the monolith packing elements, relative to the costs and time required to load an equivalent amount of randomly oriented packing elements, increases the cost of operating the mass transfer process and therefore may be undesirable.

Conventional wisdom indicates that the most efficient mass transfer elements are those that present the largest surface area per unit volume, also known as the packing element's geometric surface area, to the fluid to be contacted. There have been many attempts to design randomly oriented packing elements with the geometric surface area maximized. However, experience has shown that other characteristics of the packing elements may be desirable and may be considered when manufacturing packing elements for use in large scale commercial operations where initial cost, operating cost, and replacement cost of the packing elements as well as the reactor's operating efficiency may be factors. Other characteristics of the packing elements that may be considered include the cost of manufacturing the packing elements, the tendency for the packing elements to nest with one another, the density of the elements, and the pressure drop within the vessel caused by the packing elements. Pressure drop may be directly impacted by the individual packing element's open face surface area and intra-element porosity as well as the porosity between the packing elements. Balancing these requirements, which may be in competition with one another, may require considerable skill to achieve an advantageous design.

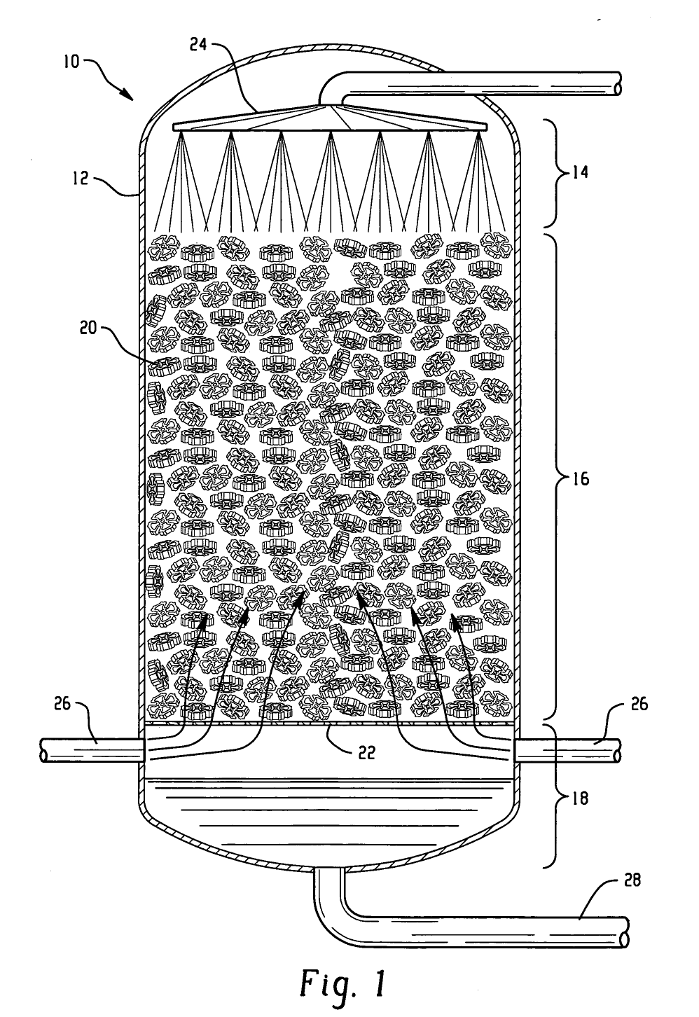

Referring now to the drawings, shown in FIG. 1 is a schematic drawing of an embodiment of a chemical processing apparatus 10 which could be used, for example, to produce sulfuric acid. In this embodiment, the processing apparatus includes reaction vessel 12 which can be generally divided into reactant entry zone 14, reaction zone 16 and product collection zone 18. A plurality of randomly oriented packing elements 20, which may be referred to herein as a “bed” of packing elements, is positioned within, for example filling, the reaction zone and is supported by porous screen 22 which has openings small enough to prevent passage of the packing elements and large enough to permit a liquid to easily flow therethrough. While the embodiment of FIG. 1 uses only packing elements according to an embodiment of this invention, a bed may employ mixtures of packing elements. In one embodiment, at least a majority of the elements are packing elements according to embodiments of this invention. Above the reaction zone is an entry zone for one of the reactants. A reactant, such as an aqueous based solution, enters the vessel and is distributed across the top of the bed of packing elements by distribution mechanism 24. As the reactant flows down and through the randomly oriented packing elements, gas comprising SO₃ flows through gas inlet pipes 26 and into the lower portion of the bed of packing elements in the reaction zone. As the SO₃ gas moves upwardly toward the top of the bed and the reactant flows toward the bottom of the bed, at least a portion of the SO₃ is absorbed by the reactant when the reactant flows over and wets the surfaces of the packing elements. Sulfuric acid is formed when the SO₃ reacts with the reactant. The sulfuric acid flows through the bed of packing elements, the porous support screen, and then collects in product collection zone 18. Discharge pipe 28 at the bottom of the collection zone may be used to remove the sulfuric acid from the vessel.

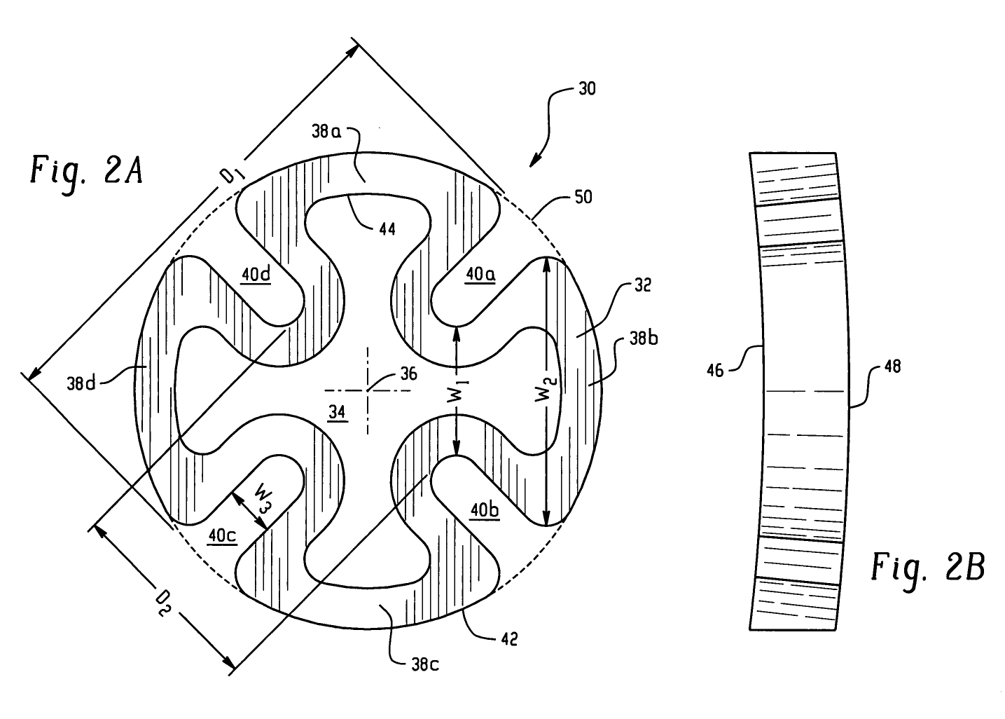

Shown in FIGS. 2A and 2B are a top view and a side view, respectively, of a first embodiment of a packing element 30 of this invention. Packing element 30 has a continuous curvilinear peripheral wall 32 that defines the perimeter of a planar symmetrically shaped space 34 which includes a centrally located common axis 36, four closed ended lobe shaped projections (38a, 38b, 38c, 38d) and four open ended channels (40a, 40b, 40c, 40d). The projections and channels are radially spaced from one another around the axis. The element has an exterior surface 42, an interior surface 44, a first end 46 and a second end 48. As used herein, “lobe shaped” projection means a projection having a first width, W₁, which is the smallest width of the projection and is located nearest the common axis, and a second width, W₂, which is the largest width of the projection and is located further away from the common axis than the first width. The ratio of W₂ to W₁ may range from approximately 1.5:1 to approximately 4:1. The four open ended channels are defined by indentations in the peripheral wall. In FIG. 2A, the lobe shaped projections are uniformly shaped, the channels are uniformly shaped and the channels have a constant width W₃ over at least a portion of their length. Other embodiments of this invention may contain additional lobes, such as six or eight lobes. The desired number of lobes may be influenced, in part, by the diameter of the packing element. As the diameter of the packing element increases, the number of lobes that can be accommodated may also increase. While an even number of lobes facilitates a symmetrical design, packing elements with three, five or seven lobes are feasible.

One of the packing element's design features that impact the performance of the bed of packing elements in a processing apparatus may be its geometric surface area. As used herein, the geometric surface area is the total surface area of all the element's surfaces that can be contacted by a fluid when the element is housed in a processing apparatus. With reference to FIGS. 2A and 2B, the geometric surface area of this element is the sum of the peripheral wall's exterior surface, the peripheral wall's interior surface, the surface of the first end and the surface of the second end. As shown in FIGS. 2A and 2B, all of the element's surface area may be contributed by nonplanar surfaces including the curvilinear ends which may be parallel to each other but form a concave shape on one side of the element and a convex shape on the other side of the element. However, if the element is shaped such that the first and second ends are parallel to each other and perpendicular to the peripheral wall, the ends would be planar surfaces. Therefore, the geometric surface area could be contributed solely by nonplanar surfaces or by a combination of nonplanar surfaces and planar surfaces. The ratio of nonplanar surface area to planar surface area can vary between 2:1 and 20:1.

As previously described, increasing the packing element's geometric surface area may be one of the design criteria that may be considered when designing a packing element to achieve the desired performance in a mass transfer application. To obtain the desired geometric surface area in one embodiment of packing elements according to this invention, the outermost portions of the lobed projections were made to coincide with portions of the perimeter of the smallest circle that encircles the packing element's entire peripheral wall and is represented in FIG. 2A by dotted line 50. Due to the existence of the four channels that are located between the four lobed projections, the surface area of the peripheral wall forms a discontinuous circle which reduces the wall's exterior surface area relative to the amount of surface area that could be attained if the peripheral wall was continuous. However, by including channels between each of the lobed projections, the total surface area of the packing element can be significantly increased while also providing multiple passageways that allow, for example, reactants and reaction products to pass through the elements in the bed without causing an unacceptable increase in pressure drop within the process apparatus.

With reference to the embodiment shown in FIG. 2A, each of the four lobed projections abuts about 20 percent of the circle's circumference. Consequently, the lobed projections collectively abut about 80 percent of the circle's circumference. Depending upon the desired amount of surface area, each projection could be made to contact between about 15 and about 22 percent of the circle's circumference thereby collectively abutting between about 60 and about 88 percent of the circle's circumference. Similarly, in FIG. 2, the channels each abut about 5 percent of the circle's circumference. The width of the channels could be adjusted so that the channels each abut between about 3 percent and about 10 percent of the circle's circumference thereby collectively abutting between about 12 and about 40 percent of the circle's circumference. If desired, the widths of the lobes and channels can be designed to abut about 70 percent and about 30 percent of the circumference, respectively. Alternatively, the widths of the lobes and channels can be designed to abut about 75 percent and about 25 percent of the circumference, respectively.

With reference to FIG. 2A, another physical parameter that may be used to characterize a mass transfer packing element is the ratio of the element's maximum diameter, D₁, to the element's minimum diameter, D₂. A 3:1 ratio of D₁: D₂ is feasible. A ratio between 1.2:1 and 5:1 may be workable.

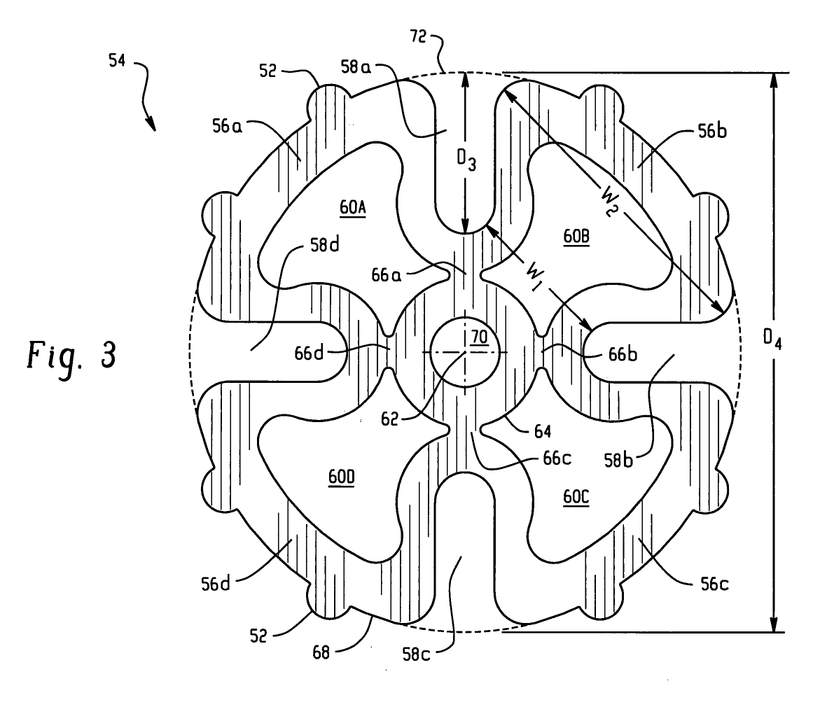

Shown in FIG. 3 is a second embodiment 54 of a packing element of this invention. Similar to the packing element shown in FIGS. 2A and 2B, FIG. 3 discloses four lobed projections 56 (a, b, c, d,) and four channels 58 (a, b, c, d) spaced between the four projections. The outer surfaces of the projections, channels and ends collectively define a disc shaped volume that is perpendicular to the common axis 62. This volume includes the volume occupied by the ceramic material and the spaces (60a, 60b, 60c and 60d) defined by the projections and channels. FIG. 3 also includes centrally located connection member 64 which is disposed between the channels and around the common axis. The connection member forms four structurally supportive connections 66 (a, b, c, d) with the peripheral wall 68 thereby forming a packing element that can withstand the rigors of manufacturing as well as the normal handling involved in transporting and then randomly dumping the packing elements into a processing apparatus. The connection member defines hole 70 through the packing element which serves as a passageway to facilitate the passage of reactants and reaction products through the bed of packing elements.

The embodiment of FIG. 3 discloses another optional feature, a rib 52 which is disposed along the peripheral wall's exterior surface. The rib serves to further increase the element's geometric surface area. While the number of ribs per element and the exact location of each rib may vary, incorporating two ribs on the outer surface of each projection may be feasible. For the purpose of defining a packing element's maximum outer diameter, D₁, as described above and visually disclosed in FIG. 2A, the height of a rib is not considered when calculating D₁. However, the rib's surface area should be included when determining the element's geometric surface area.

As disclosed in FIG. 3, the channels may be formed by indentations in the peripheral wall. The ratio of the length of the indentation to the width of the packing element is a criterion that may be used to specify the design of the element. The length of the channel, D₃, is defined as the distance from the circumference of the circle 72 that abuts the exterior surface of the lobed projections to the exterior surface of the indentation's inner most recess. The width of the element, D₄, is the diameter of the circle that encompasses the element. In FIG. 3, the ratio of the element's diameter to the length of the channel is approximately 4:1. Ratios of 3:1 to 6:1 are feasible.

Packing elements according to embodiments of the invention can be formed from any material that provides sufficient strength and does not deteriorate at an unacceptably high rate when exposed to the materials disposed in the chemical processing apparatus. For example, ceramic materials such as natural or synthetic clays, feldspars, zeolites, cordierites, aluminas, zirconia, silica or mixtures of these may be used. Clays are generically mixed oxides of alumina and silica and include materials such as kaolin, ball clay, fire clay, china clay, and the like. Example clays are high plasticity clays, such as ball clay and fire clay. The clay may have a methylene blue index, (“MBI”), of about 11 to 13 meq/100 gm. The term “feldspars” may be used herein to describe silicates of alumina with soda, potash and lime. Other components such as quartz, zircon sand, feldspathic clay, montmorillonite, nepheline syenite, and the like can also be present in minor amounts of the other ceramic-forming components.

Components to be fired together to produce the packing elements may be supplied in fine powder form and may be made into a shapeable mixture by the addition of a liquid, such as water, and optional processing aids, such as bonding agents, extrusion aids, lubricants, and the like to assist in the extrusion process. The mixture can be processed using several different techniques, such as extrusion or pressing, to achieve the desired shape. For example, an initial extrusion process may be followed by cutting the extrudate perpendicular to the direction of extrusion as the extrudate exits the extruder. To obtain packing elements having first and second ends that are curved as disclosed in FIG. 2B, the extruder may be stopped after extruding a length of extrudate so that a cutting mechanism having several blades and an equal number of curved blade guides can be used to simultaneously cut a plurality of packing elements having the desired length and curved ends. After cutting the packing element to the desired length, an initial drying may be used to drive off water. This may avoid disrupting the relatively weak structure of the greenware and may be carried out at below about 120° C. and, in one embodiment, below about 70° C. and may last for about 5 hours. The bodies may then be processed at high temperatures wherein the maximum temperature may be greater than 1100° C. and less than 1400° C. Maximum firing temperatures between 1200° C. and 1250° C. are common. The firing temperature may depend, to some degree, on the composition of the elements, and in general, may be sufficient for the bulk of the material to achieve a structurally sound body.

In one embodiment, the ceramic elements may be fabricated from a mixture of clays and feldspars and other minor ingredients to form a resultant body that may be comprised mainly of silicon oxide and aluminum oxide (an aluminosilicate). For example, the mixture used to form the elements may comprise at least about 90% of ceramic forming ingredients and the balance (typically up to about 10%) of processing aids. The ceramic forming ingredients may comprise 20-99% aluminum oxide and 0-80% silicon oxide. The processing aids may be largely volatilized during firing. It will be appreciated, however, that the packing elements can be composed of any material that is essentially inert to the material disposed in the processing apparatus and provides sufficient crush strength to prevent crushing of the packing elements when they are dumped into the apparatus. The components may be thoroughly mixed before adding water in an amount sufficient to enable the mixture to be shaped into the desired form and to retain that form during firing. Generally, the amount of water added may be from 12 to 30 ml for every 100 gm of the dry mixture of the components. The shapeable mixture can then be molded, or extruded to form the desired shape before the firing the shape in a kiln to a maximum temperature of from 1100° C. to 1400° C. The temperature in the kiln may be increased at a rate of between 50 to 90° C./hr. and the dwell time at the calcining temperature may be from 1 to 4 hrs before the kiln cools to ambient temperatures.

The above description is considered that of particular embodiments only. Modifications of the invention will occur to those skilled in the art and to those who make or use the invention. Therefore, it is understood that the embodiments shown in the drawings and described above are merely for illustrative purposes and are not intended to limit the scope of the invention, which is defined by the following claims as interpreted according to the principles of patent law, including the Doctrine of Equivalents.

I claim:

1. A packing element, comprising: a peripheral wall defining at least three lobes and at least three channels radially disposed around a common axis and alternately spaced from one another, wherein the lobes abut at least 60% of the circumference of the smallest circle that circumscribes the wall and wherein the channels form openings that abut no more than 40% of the circumference.

2. The packing element of claim 1, wherein said lobes and channels are disposed in a plane oriented perpendicular to the common axis.

3. The packing element of claim 1, wherein said lobes are uniformly shaped.

4. The packing element of claim 1, wherein said channels are uniformly shaped.

5. The packing element of claim 1, wherein said lobes abut at least 70% of the circumference.

6. The packing element of claim 5, wherein said channels form openings that abut no more than 30% of the circumference.

7. The packing element of claim 1, wherein said lobes abut at least 75% of the circumference.

8. The packing element of claim 7, wherein said channels form openings that abut no more than 25% of the circumference.

9. The packing element of claim 1, wherein said packing element comprises at least four lobes and at least four channels.

10. The packing element of claim 9, wherein said packing element comprises no more than eight lobes.

11. The packing element of claim 1, wherein each of said lobes comprises a first width and a second width, said first width less than said second width and said first width closer than the second width to the common axis.

12. The packing element of claim 1, wherein the packing element has a maximum diameter, each channel has a maximum length and the ratio of the packing element's diameter to the length of a channel is at least 1.2:1.

13. The packing element of claim 12, wherein the packing element has a minimum diameter and the ratio of the packing element's maximum diameter to the packing element's minimum diameter is at least 3:1.

14. The packing element of claim 1, further comprising a connection member disposed between said channels and around the packing element's common axis, said connection member forming a plurality of structurally supportive connections with said peripheral wall.

15. The packing element of claim 14, wherein said packing element comprises at least four connections between said wall and said connection member.

16. The packing element of claim 14, wherein said connection member defines a hole through said packing element.

17. The packing element of claim 1, having a geometric surface area comprising nonplanar surface area.

18. The packing element of claim 17, wherein said geometric area comprises planar surface area.

19. The packing element of claim 18, wherein the ratio of nonplanar surface area to planar surface area is between 2:1 and 20:1.

20. The packing element of claim 1, wherein said packing element comprises an exterior surface, at least one interior surface, a first end and a second end.

21. The packing element of claim 20 wherein said interior and exterior surfaces are parallel to one another and perpendicular to said first and second ends.

22. The packing element of claim 20, wherein said interior and exterior surfaces define curvilinear surfaces and said first and second ends define planar surfaces.

23. The packing element of claim 20, wherein said interior and exterior surfaces are parallel to each other and said first and second ends are parallel to each other.

24. The packing element of claim 1, further comprises at least one rib disposed on the peripheral wall.

25. The packing element of claim 24, wherein each lobe comprises at least two ribs.

26. The packing element of claim 1, wherein said wall is curvilinear.

27. A chemical processing apparatus, comprising a plurality of randomly oriented ceramic packing elements, the majority of said elements each comprising a peripheral wall defining at least three lobes and at least three channels radially disposed around a common axis and alternately spaced from one another, wherein the lobes abut at least 60% of the circumference of the smallest circle that circumscribes the wall and the channels form openings that abut no more than 40% of the circumference.

28. The chemical processing apparatus of claim 27, wherein said lobes and channels are disposed in a plane oriented perpendicular to the common axis.

29. The chemical processing apparatus of claim 27, wherein said channels are uniformly shaped and said lobes are uniformly shaped.

30. The chemical processing apparatus of claim 27, wherein said lobes abut at least 70% of the circumference and said channels form openings that abut no more than 30% of the circumference.

31. The chemical processing apparatus of claim 27, wherein said packing element comprises at least four lobes and at least four channels.

32. The chemical processing apparatus of claim 27, further comprising a connection member disposed between said channels and around the packing element's common axis, said connection member forming a plurality of structurally supportive connections with said peripheral wall.

33. The chemical processing apparatus of claim 32, wherein said connection member defines a hole through said packing element.

34. A mass transfer process comprising the step of simultaneously exposing at least two fluids to a plurality of randomly oriented ceramic packing elements wherein the majority of the elements each comprise a peripheral wall that defines at least three lobes and at least three channels radially disposed around a common axis and alternately spaced from one another wherein the lobes abut at least 60% of the circumference of the smallest circle that circumscribes the wall and the channels form openings that abut no more than 40% of the circumference.

35. The mass transfer process of claim 34, further comprising a chemical processing apparatus having said plurality of randomly oriented packing elements disposed therein.
